(19) United States
(12) Patent Application Publication
(10) Pub. No.: US 2003/0098740 A1
(43) Pub. Date: May 29, 2003

(54) MOS-based voltage reference circuit

(76) Inventors: Tsung Hsuan Hsieh, Tainan (TW); Yao Wen Chang, Hsinchu (TW); Tao Cheng Lu, Kaohsiung (TW)

Correspondence Address: BIRCH STEWART KOLASCH & BIRCH, PO BOX 747, FALLS CHURCH, VA, 22040-0747, US

(21) Appl. No.: 09/994,797

(22) Filed: Nov. 28, 2001

(51) Int. Cl. G05F 3/02

(52) U.S. Cl. 327/543

(57) ABSTRACT

The invention discloses a voltage reference circuit, which includes a first resistor, a second resistor and a MOS device. In the invention, the MOS device is connected in series between the first resistor and the second resistor and a gate of the MOS device is electrically connected to a drain of the MOS device. The MOS device can be an NMOS, wherein the drain of the NMOS is electrically connected to the second resistor, a source of the NMOS is electrically connected to the first resistor, and a bulk of the NMOS is electrically connected to the source of the NMOS or ground. The MOS device can also be a PMOS, wherein the source of the PMOS is electrically connected to the second resistor, the drain of the PMOS is electrically connected to the first resistor, and the bulk of the PMOS is electrically connected to the source of the PMOS or a voltage source.

### BACKGROUND OF THE INVENTION

1. Field of Invention

The invention relates to a metal-oxide-semiconductor (MOS) transistor based voltage reference circuit that provides a stable voltage reference at different temperatures.

2. Related Art

In integrated circuits, several work voltages are required to drive individual devices. For example, some devices work at 3.3 V while others at 2.6 V.

Generally speaking, the voltage imposed on one semiconductor chip is fixed. In order to drive the devices of the internal circuit of a semiconductor chip, the existence of a reference voltage is necessary so that the voltage on each of the devices can be adjusted to the correct voltage. For example, when the voltage imposed on a semiconductor chip is 5 V and the work voltage of the driven device is 2.6 V, then the 5 V voltage has to be adjusted to 2.6 V by a 2.4 V reference voltage so as to correctly drive the device.

In conventional techniques, the bipolar junction transistor (BJT) is one of the most common used voltage reference circuits. However, for IC designers, the reference voltage provided by the BJT is not easily adjusted. As an example, suppose one needs a 2.4 V reference voltage, 4 sets of 0.6 V reference voltage BJTs have to be connected in series to provide the 2.4 V reference voltage.

In addition, the semiconductor chip produces heat during its operation and thus increases its own temperature. When the temperature of the semiconductor chip changes, the reference voltage provided by the BJT also varies. For example, a BJT can provide a 0.6 V reference voltage at 20 degrees Celsius. After the semiconductor chip operates for a period of time, the temperature becomes 60 degrees Celsius. Thus, the BJT in the semiconductor chip cannot provide the correct 0.6 V reference voltage. So, when a 5 V voltage is imposed thereon, one is not able to get a 2.6 V work voltage from the 4 sets of BJT's. This may result in the malfunction of some devices in the semiconductor.

As described before, how to provide a voltage reference circuit with a stable reference voltage at different temperatures is an important issue under study.

### SUMMARY OF THE INVENTION

An objective of the invention is to provide a voltage reference circuit that can provide a stable reference voltage at different temperatures.

The invention uses the property that the current flowing through an MOS device imposed with a specific voltage will keep a constant value at different temperatures. In other words, when the current flowing through the MOS device is of a specific value, the reference voltage provided by the MOS device is a fixed value.

To achieve the above objective, the disclosed voltage reference circuit includes a first resistor, a second resistor and a MOS device. In the invention, the MOS device is connected in series between the first resistor and the second resistor and the gate of the MOS device is electrically connected to the drain of the MOS device.

In accordance with this invention, the MOS device can be an NMOS. The drain of the NMOS is electrically connected to the second resistor, the source of the NMOS is electrically connected to the first resistor, and the bulk of the NMOS can be electrically connected with its drain or ground.

As shown in FIG. 1A, the gate 121 of the NMOS is electrically connected to the drain 122 of the NMOS. The bulk 124 of the NMOS is electrically connected to the source 123 of the NMOS. When the bulk 124 and the source 123 of the NMOS are connected to ground, a voltage source V_{DD} enters from the drain of the NMOS. Under different operating temperatures (−20° C.˜80° C.), the relation between V_{DD} and the current I_{CP} flowing through the NMOS are shown in FIG. 1B. From FIG. 1B, one can see that at all temperatures (−20° C.˜80° C.), V_{DD} is fixed at 1.2 V when I_{CP} is 1.036E-4A (the V_{DD} at this condition is called V_{CP}). In other words, FIG. 1B implies that the NMOS has a fixed V_{CP} at different temperatures.

As shown in FIG. 2A, if the NMOS is used as a basis to provide a stable reference voltage source, then the current flowing through the NMOS has to be fixed at I_{CP}. Therefore, a second resistor R2 has to be provided between the voltage source V_{DD} and the source of the NMOS so as to adjust the current through the NMOS to I_{CP}.

In addition, in order to provide different reference voltages at the drain of the NMOS, the source of the NMOS is electrically connected to a first resistor R1 so as to adjust the reference voltage.

As described before, when the voltage of the voltage source is V_{DD} and the reference voltage provided by the drain of the NMOS is V_{REF}, the current I_{REF} is set as I_{CP}, with the corresponding reference voltage of the NMOS being V_{CP}. At the moment, the values of the first resistor R1 and the second resistor R2 can be expressed by

R1=(V_{REF}−V_{CP})/I_{CP} (1)

R2=(V_{DD}−V_{REF})/I_{CP} (2)

FIG. 2B shows the relation between the resistance of the first resistor R1 and the reference voltage V_{REF}, and the relation between the resistance of the second resistor R2 and the reference voltage V_{REF}.

Moreover, the MOS device can be a PMOS. The source of the PMOS is electrically connected to the second resistor, the drain of the PMOS is electrically connected to the first resistor, and the bulk of the PMOS can be electrically connected with its source or a voltage source V_{DD}.

In summary, the invention utilizes the property that the reference voltage provided by an MOS device is a constant that does not vary with the temperature when a fixed current flows through the MOS device. The MOS device is companied with the first resistor and the second resistor so that the second resistor sets the value of the current flowing through the MOS device and the first resistor sets the value of the reference voltage provided. Therefore, the invention can provide a stable reference voltage at different temperatures.

### BEIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1A is a schematic diagram of an NMOS device;

FIG. 1B is a coordinate diagram showing the circuit character of the NMOS in FIG. 1A at different temperatures;

FIG. 2A is a schematic diagram of the voltage reference circuit in a preferred embodiment;

FIG. 2B is a coordinate diagram showing the circuit characteristics of the first resistor and the second resistor in FIG. 2A;

FIG. 2C is a schematic diagram of another voltage reference circuit;

FIG. 3 is a coordinate diagram showing the circuit characteristics of the voltage reference circuit shown in FIG. 2A;

FIG. 4A is a schematic diagram of yet another voltage reference circuit; and

FIG. 4B is a schematic diagram of a fourth voltage reference circuit.

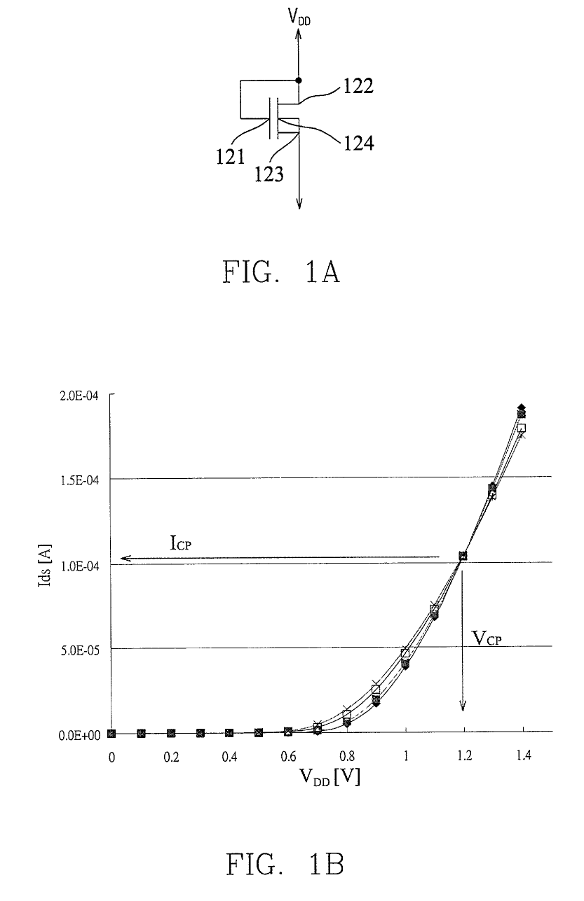

### DETAILED DESCRIPTION OF THE PREFERRED EMBODIMENT

The invention will be apparent from the following detailed description, which proceeds with reference to the accompanying drawings, wherein the same references relate to the same elements.

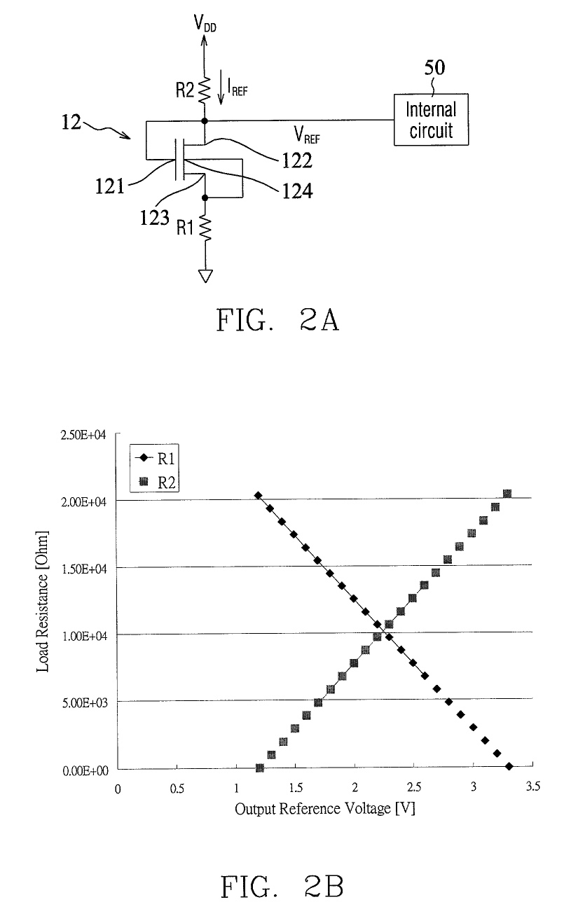

With reference to FIG. 2A, a preferred embodiment of the disclosed voltage reference circuit includes a first resistor R1, a second resistor R2, and an NMOS 12. The NMOS 12 in the embodiment is a four-terminal device, namely a gate 121, a drain 122, a source 123 and a bulk 124. The gate 121 is electrically connected to the drain 122, and the drain 122 is electrically connected to one end of the second resistor R2. The drain 122 further provides a reference voltage V_{REF} for an internal circuit 50. The source 123 is electrically connected to the bulk 124 and one end of the first resistor R1. The other end of the second resistor R2 is electrically connected to a voltage source V_{DD}, and the other end of the first resistor R1 is electrically connected to ground. According to the embodiment, the voltage provided by the voltage source V_{DD} is 3.3 V and the necessary reference voltage V_{REF} is 2 V. In the embodiment according to the invention, the V_{CP} is 1.2 V and the I_{CP} is 1.036E-4A. From Equations (1), (2) and the above parameters, one can obtain that the resistance values of the second resistor R2 and the first resistor R1 are 12548Ω and 7722Ω, respectively.

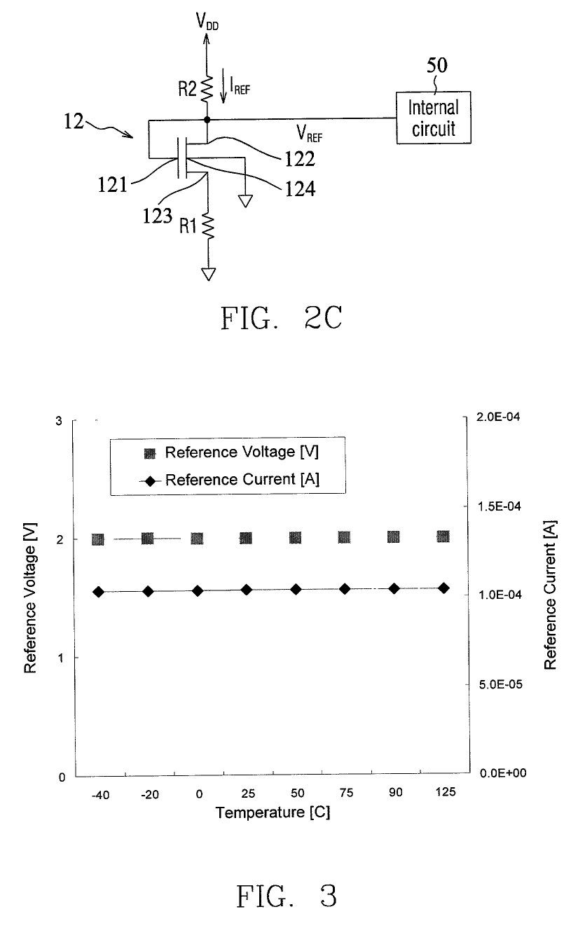

As described before, since the second resistor R2 has a resistance of 12548Ω and the first resistor R1 has a resistance of 7722Ω, the voltage reference circuit can provide a stable voltage of 2 V at different temperatures (−40° C.˜125° C.), as shown in FIG. 3.

Referring to FIG. 2C, another embodiment of the disclosed voltage reference circuit includes a second resistor R2, a first resistor R1 and an NMOS 12. In the embodiment, the NMOS 12 in the embodiment is a four-terminal device, namely a gate 121, a drain 122, a source 123 and a bulk 124. The gate 121 is electrically connected to the drain 122, and the drain 122 is electrically connected to one end of the second resistor R2. The drain 122 further provides a reference voltage V_{REF} for an internal circuit 50. The bulk 124 is connected to ground, and the source 123 is electrically connected to one end of the first resistor R1. The other end of the second resistor R2 is electrically connected to a voltage source V_{DD}, and the other end of the first resistor R1 is electrically connected to ground.

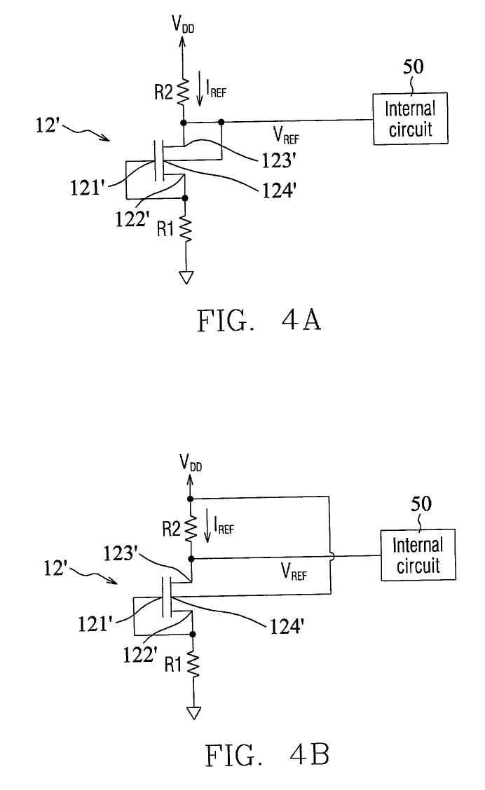

Referring to FIG. 4A, a third embodiment of the disclosed voltage reference circuit includes a second resistor R2, a first resistor R1 and a PMOS 12′. In the embodiment, the PMOS 12′ is a four-terminal device, namely a gate 121′, a drain 122′, a source 123′ and a bulk 124′. The gate 121′ is electrically connected to the drain 122′, and the drain 122′ is electrically connected to one end of the first resistor R1. The bulk 124′ is connected to the source 123′, and the source 123′ is electrically connected to one end of the second resistor R2. The source 123′ also provides a reference voltage V_{REF} to an internal circuit 50. The other end of the second resistor R2 is electrically connected to a voltage source V_{DD}, and the other end of the first resistor R1 is electrically connected to ground.

Referring to FIG. 4B, a fourth embodiment of the disclosed voltage reference circuit includes a second resistor R2, a first resistor R1 and a PMOS 12′. In the embodiment, the PMOS 12′ is a four-terminal device, namely a gate 121′, a drain 122′, a source 123′ and a bulk 124′. The gate 121′ is electrically connected to the drain 122′, and the drain 122′ is electrically connected to one end of the first resistor R1. The bulk 124′ is connected to a voltage source V_{DD}, and the source 123′ is electrically connected to one end of the second resistor R2. The source 123′ also provides a reference voltage V_{REF} to an internal circuit 50. The other end of the second resistor R2 is electrically connected to a voltage source V_{DD}, and the other end of the first resistor R1 is electrically connected to ground.

As described before, the reference voltage V_{REF} in the voltage reference circuits disclosed herein can be adjusted according to the internal circuit 50. The reference voltage V_{REF} is determined by the resistance values of the first resistor R1 and the second resistor R2. Thus, varying both the resistance values of the first and second resistors R1, R2 can change the reference voltage V_{REF} to the internal circuit 50. For example, setting the resistance of the second resistor R2 as 17375Ω and that of the first resistor R1 as 2895Ω gives a reference voltage of V_{REF}=1.5 V.

In accordance with the disclosed voltage reference circuit, the NMOS or the PMOS can be another set of V_{CP} and I_{CP}. Therefore, when the NMOS 22 has V_{CP}=0.75 V and I_{CP}=4.5E-6A with R2=288889Ω and R1=277778Ω, the reference voltage is V_{REF}=2 V.

The invention utilizes a special property of the MOS device that when a fixed current flows through the MOS device, the reference voltage provided by the MOS device is a constant that does not change with the temperature. Varying the second resistor in the invention changes the current flowing through the MOS device and the first resistor sets the reference voltage that the invention can provide. Therefore, the invention can provide a stable reference voltage at different temperatures.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A voltage reference circuit, which comprises:
a first resistor;
a second resistor; and
an MOS (Metal-Oxide Semiconductor) device, which is connected in series between the first resistor and the second resistor and a gate of the MOS device is electrically connected to a drain of the MOS device.

2. The circuit of claim 1, wherein the MOS device is a NMOS, the drain of the MOS device is electrically connected to the second resistor, and a source of the MOS device is electrically connected to the first resistor.

3. The circuit of claim 2, wherein a bulk of the MOS device is electrically connected to the source of the MOS device.

4. The circuit of claim 2, wherein a bulk of the MOS device is electrically connected to ground.

5. The circuit of claim 1, wherein the MOS device is a PMOS, a source of the MOS device is electrically connected to the second resistor, and the drain of the MOS device is electrically connected to the first resistor.

6. The circuit of claim 5, wherein a bulk of the MOS device is electrically connected to the source of the MOS device.

7. The circuit of claim 5, wherein a bulk of the MOS device is electrically connected to a voltage source V_{DD}.
